(19) United States
(12) Patent Application Publication
(10) Pub. No.: US 2013/0019157 A1
(43) Pub. Date: Jan. 17, 2013

(54) DEFECT FORM QUALITY INDICATION

(71) Applicants: Andre Weinand, Zurich (CH); Geoffrey Michael Clemm, Concord, MA (US); Benjamin Pasero, Adliswil (CH)

(72) Inventors: Andre Weinand, Zurich (CH); Geoffrey Michael Clemm, Concord, MA (US); Benjamin Pasero, Adliswil (CH)

(73) Assignee: International Business Machines Corporation, Armonk, NY (US)

(21) Appl. No.: 13/182,200

(22) Filed: Jul. 13, 2011

(51) Int. Cl. G06F 17/00

(52) U.S. Cl. 715/224

(57) ABSTRACT

A method, computer program product, and system for defect form quality indication is described. A method may comprise providing, via one or more computing devices, an indication of a relative importance of a first data entry field included in a defect entry form. The method may further comprise determining, via the one or more computing devices, a first field quality level of user input corresponding to the first data entry field included in the defect entry form. The method may additionally comprise providing, via the one or more computing devices, an indication of the first field quality level of the user input corresponding to the first data entry field included in the defect entry form.

### BACKGROUND OF THE INVENTION

Software projects may include multiple phases of testing and resolving defects in a product. Testers and/or developers, among others, may find defects and fill out defect entry forms in order to report the defects. These defects may be managed by a team member and/or manager and may be handled by one or more developers on the project. Some defect entry forms may not include enough information about the defect in order for the defect to be handled properly by the manager and/or developer.

### BRIEF SUMMARY OF THE INVENTION

In an embodiment, a method may include providing, via one or more computing devices, an indication of a relative importance of a first data entry field included in a defect entry form. The method may further include determining, via the one or more computing devices, a first field quality level of user input corresponding to the first data entry field included in the defect entry form. The method may also include providing, via the one or more computing devices, an indication of the first field quality level of the user input corresponding to the first data entry field included in the defect entry form.

One or more of the following features may be included. The method may include determining a form quality level of the defect entry form based upon, at least in part, the first field quality level of the user input corresponding to the first data entry field included in the defect entry form and a second field quality level of user input corresponding to a second data entry field included in the defect entry form. The method may additionally include providing an indication of the form quality level of the defect entry form. The method may also include updating, in real time, the indication of the first field quality level of the user input corresponding to the first data entry field included in the defect entry form, as a user enters input into the first data entry field included in the defect entry form. The method may further include updating, in real time, the indication of the form quality level of the defect entry form, as a user enters input into at least one of the first data entry field and the second data entry field included in the defect entry form.

In an implementation, the first field quality level of user input corresponding to the first data entry field included in the defect entry form may be based upon, at least in part, a search for keywords entered into the first data entry field by a user. Further, the form quality level of the defect entry form may be based upon, at least in part, one or more items attached to the defect entry form. Also, the form quality level of the defect entry form may be based upon, at least in part, a correlation between one or more keywords found in the first data entry field and one or more items attached to the defect entry form. Additionally, the form quality level of the defect entry form may be based upon, at least in part, a degree of similarity to another defect entry form. Moreover, the form quality level of the defect entry form may be based upon, at least in part, an average form quality level for a user associated with the defect entry form.

In an embodiment, a computer program product may reside on a computer readable storage medium and may have a plurality of instructions stored on it. When executed by a processor, the instructions may cause the processor to perform operations including providing an indication of a relative importance of a first data entry field included in a defect entry form. The operations may further include determining a first field quality level of user input corresponding to the first data entry field included in the defect entry form. The operations may also include providing an indication of the first field quality level of the user input corresponding to the first data entry field included in the defect entry form.

One or more of the following features may be included. The operations may include determining a form quality level of the defect entry form based upon, at least in part, the first field quality level of the user input corresponding to the first data entry field included in the defect entry form and a second field quality level of user input corresponding to a second data entry field included in the defect entry form. The operations may additionally include providing an indication of the form quality level of the defect entry form. The operations may also include updating, in real time, the indication of the first field quality level of the user input corresponding to the first data entry field included in the defect entry form, as a user enters input into the first data entry field included in the defect entry form. The operations may further include updating, in real time, the indication of the form quality level of the defect entry form, as a user enters input into at least one of the first data entry field and the second data entry field included in the defect entry form.

In an implementation, the first field quality level of user input corresponding to the first data entry field included in the defect entry form may be based upon, at least in part, a search for keywords entered into the first data entry field by a user. Further, the form quality level of the defect entry form may be based upon, at least in part, one or more items attached to the defect entry form. Also, the form quality level of the defect entry form may be based upon, at least in part, a correlation between one or more keywords found in the first data entry field and one or more items attached to the defect entry form. Additionally, the form quality level of the defect entry form may be based upon, at least in part, a degree of similarity to another defect entry form. Moreover, the form quality level of the defect entry form may be based upon, at least in part, an average form quality level for a user associated with the defect entry form.

In an embodiment, a computing system is provided. The computing system may include at least one processor and at least one memory architecture coupled with the at least one processor. The computing system may also include a first software module executable by the at least one processor and the at least one memory architecture, wherein the first software module may be configured to provide an indication of a relative importance of a first data entry field included in a defect entry form. Further, the computing system may include a second software module which may be configured to determine a first field quality level of user input corresponding to the first data entry field included in the defect entry form. Additionally, the computing system may include a third software module which may be configured to provide an indication of the first field quality level of the user input corresponding to the first data entry field included in the defect entry form.

In an implementation, the computing system may include a fourth software module which may be configured to determine a form quality level of the defect entry form based upon, at least in part, the first field quality level of the user input corresponding to the first data entry field included in the defect entry form and a second field quality level of user input corresponding to a second data entry field included in the defect entry form. The computing system may also include a fifth software module which may be configured to provide an indication of the form quality level of the defect entry form.

The details of one or more implementations are set forth in the accompanying drawings and the description below. Other features and advantages will become apparent from the description, the drawings, and the claims.

### BRIEF DESCRIPTION OF THE SEVERAL VIEWS OF THE DRAWINGS

FIG. 1 is a diagrammatic view of a quality indication process coupled to a distributed computing network;

FIG. 2 is a flowchart of the quality indication process of FIG. 1;

FIG. 3 is a graphical user interface which may be associated with the quality indication process of FIG. 1; and

FIG. 4 is also a graphical user interface which may be associated with the quality indication process of FIG. 1.

### DETAILED DESCRIPTION OF THE INVENTION

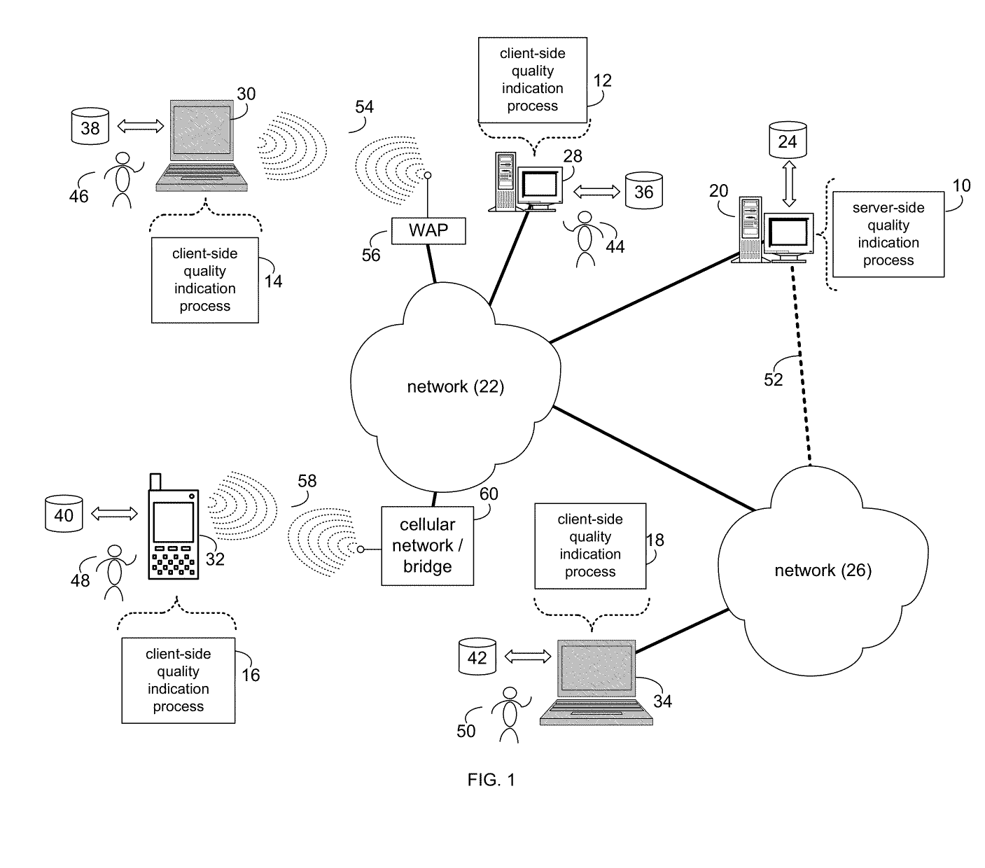

Referring to FIGS. 1 & 2, there is shown a quality indication process 10. As will be discussed below, quality indication process 10 may provide 100 an indication of a relative importance of a first data entry field included in a defect entry form. Quality indication process 10 may also determine 102 a first field quality level of user input corresponding to the first data entry field included in the defect entry form. Quality indication process 10 may further provide 104 an indication of the first field quality level of the user input corresponding to the first data entry field included in the defect entry form.

The quality indication (QI) process may be a server-side process (e.g., server-side QI process 10), a client-side process (e.g., client-side QI process 12, client-side QI process 14, client-side QI process 16, or client-side QI process 18), or a hybrid server-side/client-side process (e.g., the combination of server-side QI process 10 and one or more of client-side QI processes 12, 14, 16, 18).

Server-side QI process 10 may reside on and may be executed by server computer 20, which may be connected to network 22 (e.g., the Internet or a local area network). Examples of server computer 20 may include, but are not limited to: a personal computer, a server computer, a series of server computers, a mini computer, and/or a mainframe computer. Server computer 20 may be a web server (or a series of servers) running a network operating system, examples of which may include but are not limited to: Microsoft Windows Server; Novell Netware; or Red Hat Linux, for example.

The instruction sets and subroutines of server-side QI process 10, which may be stored on storage device 24 coupled to server computer 20, may be executed by one or more processors (not shown) and one or more memory architectures (not shown) incorporated into server computer 20. Storage device 24 may include but is not limited to: a hard disk drive; a tape drive; an optical drive; a RAID array; a random access memory (RAM); and a read-only memory (ROM).

Server computer 20 may execute a web server application, examples of which may include but are not limited to: Microsoft IIS, Novell Web Server, or Apache Web Server, that allows for access to server computer 20 (via network 22) using one or more protocols, examples of which may include but are not limited to HTTP (i.e., HyperText Transfer Protocol), SIP (i.e., session initiation protocol), and the Lotus® Sametime® VP protocol. Network 22 may be connected to one or more secondary networks (e.g., network 26), examples of which may include but are not limited to: a local area network; a wide area network; or an intranet, for example.

Client-side QI processes 12, 14, 16, 18 may reside on and may be executed by client electronic devices 28, 30, 32, and/or 34 (respectively), examples of which may include but are not limited to personal computer 28, laptop computer 30, a data-enabled mobile telephone 32, notebook computer 34, personal digital assistant (not shown), smart phone (not shown) and a dedicated network device (not shown), for example. Client electronic devices 28, 30, 32, 34 may each be coupled to network 22 and/or network 26 and may each execute an operating system, examples of which may include but are not limited to Microsoft Windows, Microsoft Windows CE, Red Hat Linux, or a custom operating system.

The instruction sets and subroutines of client-side QI processes 12, 14, 16, 18, which may be stored on storage devices 36, 38, 40, 42 (respectively) coupled to client electronic devices 28, 30, 32, 34 (respectively), may be executed by one or more processors (not shown) and one or more memory architectures (not shown) incorporated into client electronic devices 28, 30, 32, 34 (respectively). Storage devices 36, 38, 40, 42 may include but are not limited to: hard disk drives; tape drives; optical drives; RAID arrays; random access memories (RAM); read-only memories (ROM); compact flash (CF) storage devices; secure digital (SD) storage devices; and memory stick storage devices.

Client-side QI processes 12, 14, 16, 18 and/or server-side QI process 10 may be processes that run within (i.e., are part of) a lifecycle management and/or defect management application (e.g., IBM® Rational® Team Concert™) Alternatively, client-side QI processes 12, 14, 16, 18 and/or server-side QI process 10 may be stand-alone applications that work in conjunction with the lifecycle management and/or defect management application. One or more of client-side QI processes 12, 14, 16, 18 and server-side QI process 10 may interface with each other (via network 22 and/or network 26).

Users 44, 46, 48, 50 may access server-side QI process 10 directly through the device on which the client-side QI process (e.g., client-side QI processes 12, 14, 16, 18) is executed, namely client electronic devices 28, 30, 32, 34, for example. Users 44, 46, 48, 50 may access server-side QI process 10 directly through network 22 and/or through secondary network 26. Further, server computer 20 (i.e., the computer that executes server-side QI process 10) may be connected to network 22 through secondary network 26, as illustrated with phantom link line 52.

The various client electronic devices may be directly or indirectly coupled to network 22 (or network 26). For example, personal computer 28 is shown directly coupled to network 22 via a hardwired network connection. Further, notebook computer 34 is shown directly coupled to network 26 via a hardwired network connection. Laptop computer 30 is shown wirelessly coupled to network 22 via wireless communication channel 54 established between laptop computer 30 and wireless access point (i.e., WAP) 56, which is shown directly coupled to network 22. WAP 56 may be, for example, an IEEE 802.11a, 802.11b, 802.11g, 802.11n, Wi-Fi, and/or Bluetooth device that is capable of establishing wireless communication channel 54 between laptop computer 30 and WAP 56. Data-enabled mobile telephone 32 is shown wirelessly coupled to network 22 via wireless communication channel 58 established between data-enabled mobile telephone 32 and cellular network/bridge 60, which is shown directly coupled to network 22.

As is known in the art, all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. As is known in the art, Bluetooth is a telecommunications industry specification that allows e.g., mobile phones, computers, and personal digital assistants to be interconnected using a short-range wireless connection.

### The Quality Indication (QI) Process

For the following discussion, server-side QI process 10 will be described for illustrative purposes. It should be noted that client-side QI process 12 may interact with server-side QI process 10 and may be executed within one or more applications that allow for communication with client-side QI process 12. However, this is not intended to be a limitation of this disclosure, as other configurations are possible (e.g., stand-alone, client-side QI processes and/or stand-alone server-side QI processes.) For example, some implementations may include one or more of client-side QI processes 12, 14, 16, 18 in place of or in addition to server-side QI process 10.

As discussed above, some defect entry forms may not include enough information about the defect in order for the defect to be handled properly by the manager and/or developer. Additional information may be needed to resolve defects corresponding to these defect entry forms, and such information may need to be requested from the defect submitter. This process of gathering extra information about the defect from the defect submitter may be slow and inefficient because the communication between managers and/or developers working on the defect and the defect submitter may be asynchronous, e.g., by email. Further, if the managers and/or developers require more information from defect submitters at the outset, the defect submitters may either not know enough information to meet the requirement, or may be discouraged from submitting the defect in the first place. As will be described below, QI process 10 may allow managers and/or developers to indicate a relative importance of different types of information requested by the defect entry form, and may provide the tester with a quality indication informing the tester of the quality of the tester's input. In this way, the tester may be able to understand which types of information are most helpful to the manager and/or developer, and the quality of the information the tester has provided to the manager and/or developer.

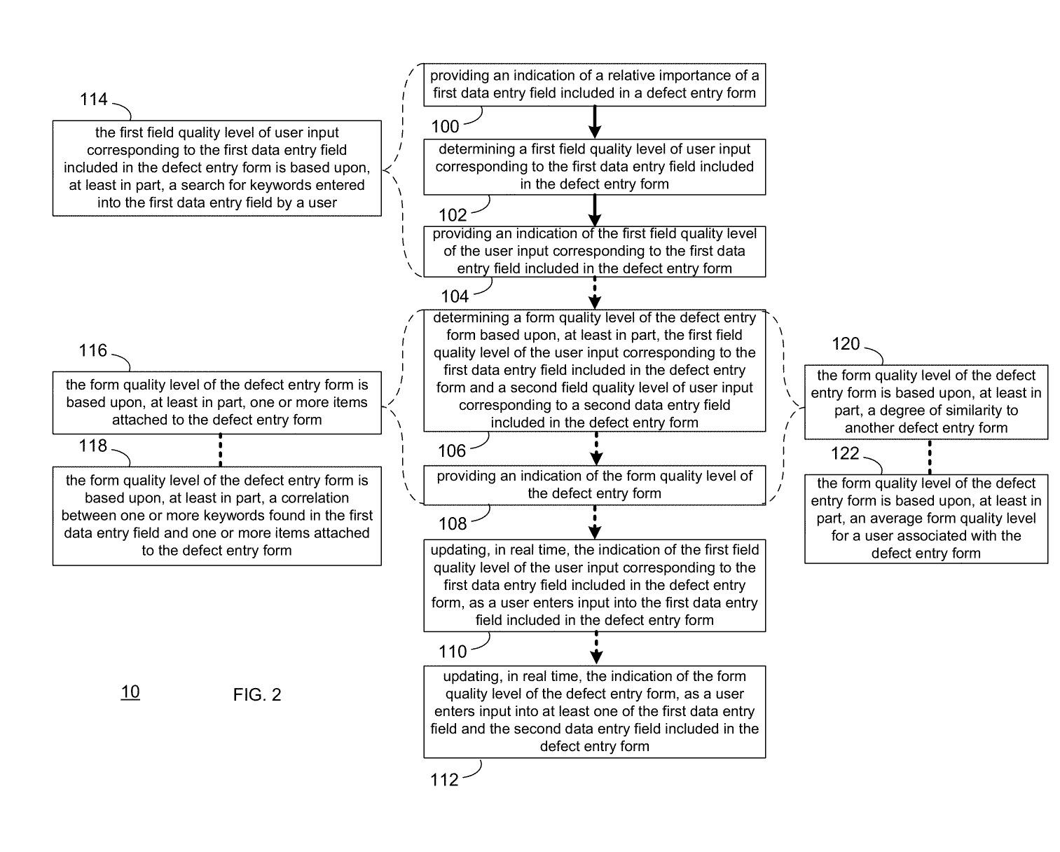

Referring now to FIGS. 1-3, QI process 10 may provide 100 an indication (e.g., one or more of indications 302, 304, 306, 308, 310) of a relative importance of a first data entry field (e.g., data entry fields 312, 314, 316, 318, 320, 322, 324) included in a defect entry form (e.g., defect entry form 300). Defect entry form 300 may be a graphical user interface associated with a lifecycle management and/or defect management application (e.g., IBM® Rational® Team Concert™). Testers may report defects via defect entry form 300. Defect entry form 300 may include one or more graphical user interface elements, including, but not limited to: text boxes, buttons, dropdown lists, list boxes, combo boxes, check boxes, and/or radio buttons. While data entry fields 312, 314, 316, 318, 320, and 322 are shown as dropdown boxes, this is for exemplary purpose only, and data entry fields 312, 314, 316, 318, 320, and 322 each may be any one of the graphical user interface elements described above. Further, while defect entry form 300 is shown to include data entry fields 312, 314, 316, 318, 320, 322, and 324, defect entry form 300 may include any number of data entry fields.

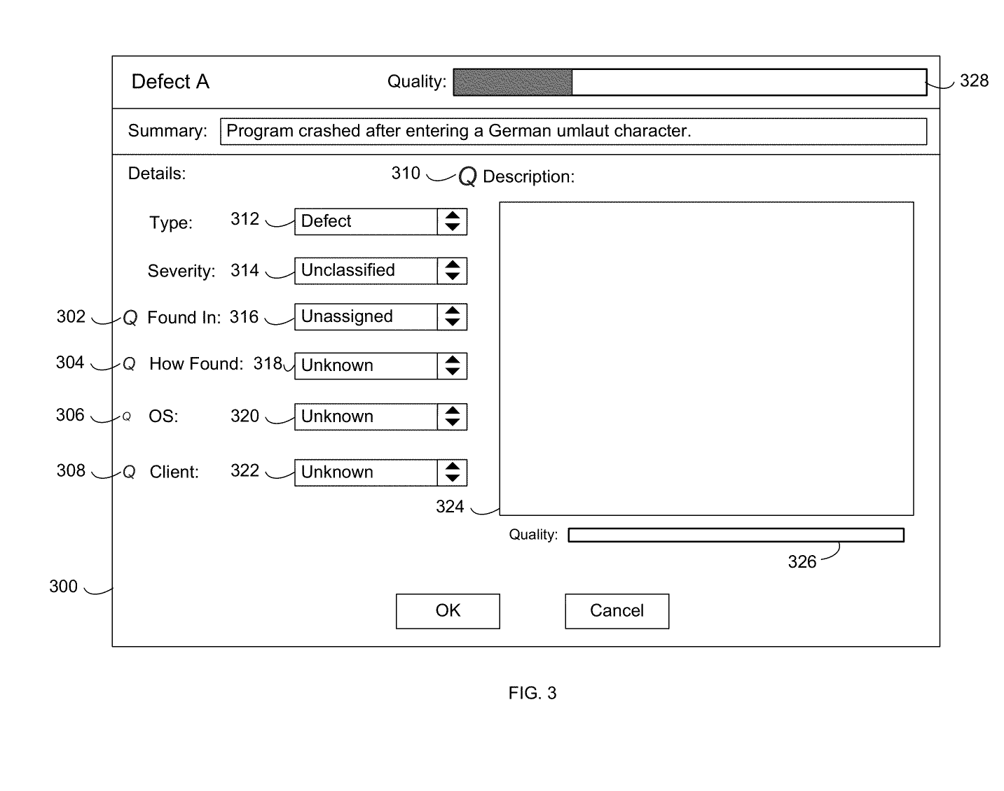

One or more of data entry fields 312, 314, 316, 318, 320, 322, and/or 324 may correspond to a characteristic associated with a defect (e.g., “Defect A” as shown in FIG. 3). These characteristics may include, but are not limited to: type, severity, where the defect was found, how the defect was found, an operating system (OS) associated with the defect, and/or a client on which the defect was found. One or more of the data entry fields (e.g., data entry field 324) may allow the tester to enter text describing the defect (e.g., “Defect A”). The relative importance of one or more of data entry fields 312, 314, 316, 318, 320, 322, and 324 may be defined by a manager and/or developer of the software project.

The relative importance of one or more of data entry fields 312, 314, 316, 318, 320, 322, 324 included in defect entry form 300 may be indicated in a number of ways. For example, QI process 10 may display an indication of the relative importance of one or more of data entry fields 312, 314, 316, 318, 320, 322, 324 near text describing what each of the data entry fields corresponds to. As shown in defect entry form 300, for exemplary purposes only, data entry field 312 may correspond to a type of the defect, data entry field 314 may correspond to a severity of the defect, data entry field 316 may correspond to where the defect was found, data entry field 318 may correspond to how the defect was found, data entry field 320 may correspond to an OS associated with the defect, data entry field 322 may correspond to a client on which the defect was found, and data entry field 324 may correspond to a description of the defect entered by the tester. Further, as shown in defect entry form 300, for exemplary purposes only, QI process 10 may display the letter “Q” near the text describing what each of the data entry fields corresponds to. The size of the letter “Q” displayed next to the description of the data entry field may vary in size and may correspond to the importance of the data entry field.

For example, indication 306, which shows a very small “Q” near the description of data entry field 320 (e.g., “OS”), may indicate that data entry field 320 has a very small relative importance as compared with other fields of data entry form 300. Further, indications 304 and 308, which show a slightly larger “Q” than indication 306, near the descriptions of data entry fields 318 and 322, respectively (e.g., “How Found” and “Client”), may indicate that data entry fields 318 and 322 are slightly more important than data entry field 320. Indication 302, which shows a larger “Q” than indications 304 and 308 near the description of data entry field 316 (e.g., “Found In”), may indicate that data entry field 302 is more important than data entry fields 318 and 322. Additionally, indication 310, which shows the largest “Q” on defect entry form 300 near the description of data entry field 324 (e.g., “Description”), may indicate that data entry field 324 is the most important data entry field on defect entry form 300.

It should be noted that while the relative importance of data entry fields 312, 314, 316, 318, 320, 322, and 324 has been described above as being indicated by varying sizes of the letter “Q” (e.g., by indications 302, 304, 306, 308, and 310, respectively), this is for exemplary purposes only, and QI process 10 may indicate the relative importance of data entry fields 312, 314, 316, 318, 320, 322, and 324 in a variety of other ways. For example, the width, boldness, and or color saturation of the letter “Q”, or another letter or word, may indicate varying degrees of importance of data entry fields 312, 314, 316, 318, 320, 322, and 324. In other implementations, QI process 10 may not display a letter to indicate the relative importance of a data entry field. For example, in other implementations, the relative importance of one or more of data entry fields 312, 314, 316, 318, 320, 322, and 324 may be indicated by various types of scales, numbers, colors, text, images, gauges, and/or meters, or other representations.

Continuing with the above example, QI process 10 may determine 102 a first field quality level (e.g., as indicted by gauge 326) of user input corresponding to the first data entry field (e.g., one or more of data entry fields 312, 314, 316, 318, 320, 322, and 324) included in the defect entry form (e.g., defect entry form 300). QI process 10 may determine a field quality level of user input corresponding to a data entry field in a variety of ways. For example, the first field quality level (e.g., as indicted by gauge 326) of user input corresponding to the first data entry field (e.g., one or more of data entry fields 312, 314, 316, 318, 320, 322, and 324) included in the defect entry form (e.g., defect entry form 300) may be (114) based upon, at least in part, a search for keywords entered into the first data entry field (e.g., data entry field 324) by a user (e.g., a tester). As shown in FIG. 3, as nothing has been entered in data entry field 324, QI process 10 may determine that there are no keywords in data entry field 324, and that the field quality level associated with data entry field 324 is very little.

QI process 10 may also provide 104 an indication (e.g., as shown by gauge 326) of the first field quality level of the user input corresponding to the first data entry field (e.g., one or more of data entry fields 312, 314, 316, 318, 320, 322, and 324) included in the defect entry form (e.g., defect entry form 300). For example, as nothing has been entered in data entry field 324 and QI process 10 may have determined that the field quality level associated with data entry field 324 is very little, gauge 326 may display that the field quality level associated with data entry field 324 is zero.

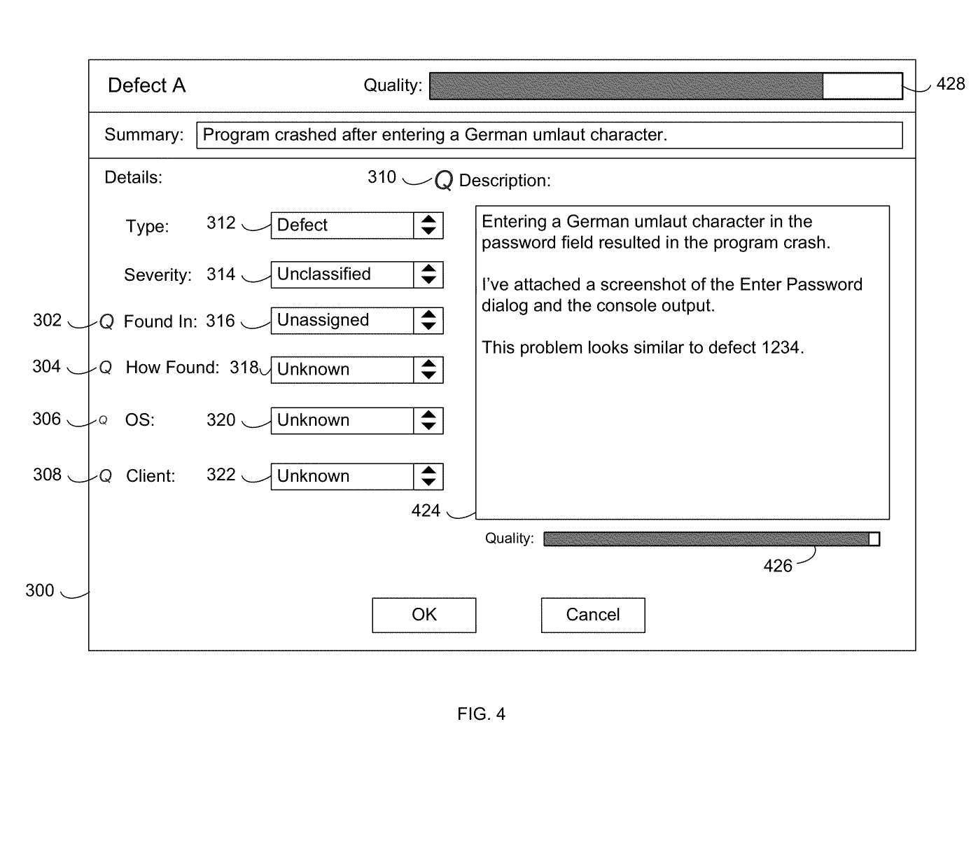

Referring now also to FIG. 4, assume for illustrative purposes that the tester that found “Defect A” entered text into data entry field 424. QI process 10 may search the text entered into data entry field 424 for keywords (e.g., “screenshot” and/or “stack trace”) and may determine that the text entered into data entry field 424 includes the keyword “screenshot”. As such, QI process 10 may determine that the field quality level associated with data entry field 424 is very high, and may indicate, via, e.g., gauge 426, that the field quality level associated with data entry field 424 is very high.

QI process 10 may also determine 106 a form quality level (e.g., as indicated by gauge 328 and/or 428) of the defect entry form (e.g., defect entry form 300) based upon, at least in part, the first field quality level (e.g., as indicated by gauge 326 and/or 426) of the user input corresponding to the first data entry field (e.g., one or more of data entry fields 312, 314, 316, 318, 320, 322, and 324) included in the defect entry form (e.g., defect entry form 300) and a second field quality level of user input corresponding to a second data entry field (e.g., one or more of data entry fields 312, 314, 316, 318, 320, 322, and 324) included in the defect entry form (e.g., defect entry form 300). For example, the form quality level may be based upon various quality measures (e.g., the first and second field quality levels) associated with one or more of data entry fields 312, 314, 316, 318, 320, 322, and 324. QI process 10 may use an algorithm for combining individual quality measures (e.g., the first and second field quality levels) into one overall quality measure of the form (e.g., the form quality level). For example, the form quality level may be the weighted sum of the first and second field quality levels. The manager and/or developer may configure weights for the first and second field quality levels based upon their relative importance. Further, QI process 10 may provide 108 an indication (e.g., as indicated by gauge 328 and/or 428) of the form quality level of the defect entry form (e.g., defect entry form 300). It should be noted that the form quality level (e.g., as indicated by gauge 328 and/or 428) of the defect entry form (e.g., defect entry form 300) may be based upon only the first field quality level (e.g., as indicated by gauge 326 and/or 426) of the user input corresponding to the first data entry field (e.g., one or more of data entry fields 312, 314, 316, 318, 320, 322, and 324) included in the defect entry form (e.g., defect entry form 300), as a second data entry field may not exist in some situations. Also, it should be noted that while the indication of the form quality level of the defect entry form is shown herein via gauge 328 and/or 428, this is for exemplary purposes only, as the indication of the form quality level may be shown by various types of scales, numbers, colors, text, images, gauges, and/or meters, or other representations.

In an implementation, the form quality level (e.g., as indicated by gauge 328 and/or 428) of the defect entry form (e.g., defect entry form 300) may be (116) based upon, at least in part, one or more items attached to the defect entry form (e.g., defect entry form 300). For example, a tester may attach a screenshot, stack trace, file, image, output, or other attachable evidence of the defect (e.g., “Defect A”) to defect entry form 300. Attachments to defect entry form 300 may indicate a higher quality of defect form 300 as such attachments may assist the manager and/or developer in handling the defect. Further, in an implementation, the form quality level (e.g., as indicated by gauge 328 and/or 428) of the defect entry form (e.g., defect entry form 300) may be (118) based upon, at least in part, a correlation between one or more keywords found in the first data entry field (e.g., one or more of data entry fields 312, 314, 316, 318, 320, 322, and 324) and one or more items (e.g., screenshot, stack trace, file, image, output, or other attachable evidence of the defect) attached to the defect entry form (e.g., defect entry form 300). For example, if the keyword “screenshot” is found in data entry field 424, and the tester also attached a screenshot to defect entry form 300, QI process 10 may determine that defect entry form 300 has a high form quality level. QI process 10 may analyze one or more items attached to defect entry form 300 and determine the type of the one or more attachments. QI process 10 may further correlate the type of attachment (e.g., a screenshot) with one or more keywords found in data entry field 424 (e.g., “screenshot”).

The form quality level (e.g., as indicated by gauge 328 and/or 428) of the defect entry form (e.g., defect entry form 300) may be based upon a number of other factors, and the examples described above are provided for illustrative purposes only. For example, the form quality level (e.g., as indicated by gauge 328 and/or 428) of the defect entry form (e.g., defect entry form 300) may be (120) based upon, at least in part, a degree of similarity to another defect entry form. Assume for illustrative purposes that, as indicated in FIG. 3, defect entry form 300 is related to “entering a German umlaut character”. Further, assume for illustrative purposes that another defect entry form associated with the same software project as defect entry form 300 is also related to “entering a German umlaut character” and has a high form quality level. QI process 10 may determine that defect entry form 300 also has a high form quality level because it describes a similar defect to another defect entry form that may provide sufficient information to resolve the defect. Further, the form quality level (e.g., as indicated by gauge 328 and/or 428) of the defect entry form (e.g., defect entry form 300) may be (122) based upon, at least in part, an average form quality level for a user (e.g., tester) associated with the defect entry form (e.g., defect entry form 300). In other words, the past quality of a tester's defect entry forms may be used as a base for any new defect entry forms submitted by the tester.

In an implementation, one or more of gauges 326, 328, 426, and 428 may be a live quality indicator. For example, QI process 10 may update 110, in real time, the indication of the first field quality level (e.g., as indicated by gauge 326 and/or 426) of the user input corresponding to the first data entry field (e.g., one or more of data entry fields 312, 314, 316, 318, 320, 322, and 324) included in the defect entry form (e.g., defect entry form 300), as a user (e.g., tester) enters input into the first data entry field (e.g., one or more of data entry fields 312, 314, 316, 318, 320, 322, and 324) included in the defect entry form (e.g., defect entry form 300). Further, QI process 10 may update 112, in real time, the indication of the form quality level (e.g., as indicated by gauge 328 and/or 428) of the defect entry form (e.g., defect entry form 300), as a user (e.g., tester) enters input into at least one of the first data entry field (e.g., one or more of data entry fields 312, 314, 316, 318, 320, 322, and 324) and the second data entry field included in the defect entry form (e.g., defect entry form 300). As used herein, the term “real time” may refer to the smallest amount of time in which QI process 10 may update and provide the indication of the first field quality level and/or the form quality level. For example, as the tester enters text into data entry field 424, QI process may determine the field quality level associated with data entry field 424 and the form quality level associated with defect entry form 300 at a high frequency, and may in turn update gauge 426 and/or 428 to reflect the latest quality level determination. In this way, QI process 10 may allow the tester to see how various types of input affect the quality level of defect entry form 300. As shown in FIGS. 3 and 4, a tester may determine, based upon viewing gauges 326, 328, 426, and 428, that entering various types of text into data entry field 424 may increase the quality for data entry field 424, and in turn, for defect entry form 300.

It should be noted that while data entry fields 324 and/or 424 are the only fields for which a field quality level is shown, QI process 10 may determine field quality levels for any of data entry fields 312, 314, 316, 318, 320, and/or 322 and may use those respective field quality levels to determine, as described above, the form quality level of defect entry form 300. For example, the form quality level of defect entry form 300 may be the weighted some of the field quality levels determined by QI process 10 for each of data entry fields 312, 314, 316, 318, 320, 322, and 324.

As will be appreciated by one skilled in the art, aspects of the present invention may be embodied as a system, apparatus, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (i.e., a client electronic device), partly on the user's computer, as a stand-alone software package, partly on the user's computer and partly on a remote computer or entirely on the remote computer or server (i.e., a server computer). In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention may be described with reference to flowchart illustrations and/or block diagrams of methods, apparatus (systems) and/or computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the figures may illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. Further, one or more blocks shown in the block diagrams and/or flowchart illustration may not be performed in some implementations or may not be required in some implementations. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A number of embodiments and implementations have been described. Nevertheless, it will be understood that various modifications may be made. Accordingly, other embodiments and implementations are within the scope of the following claims.

What is claimed is:

1. A method comprising:
providing, via one or more computing devices, an indication of a relative importance of a first data entry field included in a defect entry form;
determining, via the one or more computing devices, a first field quality level of user input corresponding to the first data entry field included in the defect entry form; and
providing, via the one or more computing devices, an indication of the first field quality level of the user input corresponding to the first data entry field included in the defect entry form.

2. The method of claim 1, further comprising:
determining a form quality level of the defect entry form based upon, at least in part, the first field quality level of the user input corresponding to the first data entry field included in the defect entry form and a second field quality level of user input corresponding to a second data entry field included in the defect entry form; and
providing an indication of the form quality level of the defect entry form.

3. The method of claim 1, further comprising:
updating, in real time, the indication of the first field quality level of the user input corresponding to the first data entry field included in the defect entry form, as a user enters input into the first data entry field included in the defect entry form.

4. The method of claim 2, further comprising:
updating, in real time, the indication of the form quality level of the defect entry form, as a user enters input into at least one of the first data entry field and the second data entry field included in the defect entry form.

5. The method of claim 1, wherein the first field quality level of user input corresponding to the first data entry field included in the defect entry form is based upon, at least in part, a search for keywords entered into the first data entry field by a user.

6. The method of claim 2, wherein the form quality level of the defect entry form is based upon, at least in part, one or more items attached to the defect entry form.

7. The method of claim 2, wherein the form quality level of the defect entry form is based upon, at least in part, a correlation between one or more keywords found in the first data entry field and one or more items attached to the defect entry form.

8. The method of claim 2, wherein the form quality level of the defect entry form is based upon, at least in part, a degree of similarity to another defect entry form.

9. The method of claim 2, wherein the form quality level of the defect entry form is based upon, at least in part, an average form quality level for a user associated with the defect entry form.

10. A computer program product residing on a computer readable storage medium having a plurality of instructions stored thereon, which, when executed by a processor, cause the processor to perform operations comprising:
providing an indication of a relative importance of a first data entry field included in a defect entry form;
determining a first field quality level of user input corresponding to the first data entry field included in the defect entry form; and
providing an indication of the first field quality level of the user input corresponding to the first data entry field included in the defect entry form.

11. The computer program product of claim 10, further comprising:
determining a form quality level of the defect entry form based upon, at least in part, the first field quality level of the user input corresponding to the first data entry field included in the defect entry form and a second field quality level of user input corresponding to a second data entry field included in the defect entry form; and
providing an indication of the form quality level of the defect entry form.

12. The computer program product of claim 10, further comprising:
updating, in real time, the indication of the first field quality level of the user input corresponding to the first data entry field included in the defect entry form, as a user enters input into the first data entry field included in the defect entry form.

13. The computer program product of claim 11, further comprising:
updating, in real time, the indication of the form quality level of the defect entry form, as a user enters input into at least one of the first data entry field and the second data entry field included in the defect entry form.

14. The computer program product of claim 10, wherein the first field quality level of user input corresponding to the first data entry field included in the defect entry form is based upon, at least in part, a search for keywords entered into the first data entry field by a user.

15. The computer program product of claim 11, wherein the form quality level of the defect entry form is based upon, at least in part, one or more items attached to the defect entry form.

16. The computer program product of claim 11, wherein the form quality level of the defect entry form is based upon, at least in part, a correlation between one or more keywords found in the first data entry field and one or more items attached to the defect entry form.

17. The computer program product of claim 11, wherein the form quality level of the defect entry form is based upon, at least in part, a degree of similarity to another defect entry form.

18. The computer program product of claim 11, wherein the form quality level of the defect entry form is based upon, at least in part, an average form quality level for a user associated with the defect entry form.

19. A computing system comprising:
at least one processor;
at least one memory architecture coupled with the at least one processor;
a first software module executable by the at least one processor and the at least one memory architecture, wherein the first software module is configured to provide an indication of a relative importance of a first data entry field included in a defect entry form;
a second software module executable by the at least one processor and the at least one memory architecture, wherein the second software module is configured to determine a first field quality level of user input corresponding to the first data entry field included in the defect entry form; and
a third software module executable by the at least one processor and the at least one memory architecture, wherein the third software module is configured to provide an indication of the first field quality level of the user input corresponding to the first data entry field included in the defect entry form.

20. The computing system of claim 19, further comprising:
a fourth software module executable by the at least one processor and the at least one memory architecture, wherein the fourth software module is configured to determine a form quality level of the defect entry form based upon, at least in part, the first field quality level of the user input corresponding to the first data entry field included in the defect entry form and a second field quality level of user input corresponding to a second data entry field included in the defect entry form; and
a fifth software module executable by the at least one processor and the at least one memory architecture, wherein the fourth software module is configured to provide an indication of the form quality level of the defect entry form.
